(19) United States
(12) Patent Application Publication
(10) Pub. No.: US 2005/0153678 A1
(43) Pub. Date: Jul. 14, 2005

(54) Method and apparatus for interaction over a network

(76) Inventor: Todd Joseph Tiberi, New York, NY (US)

Correspondence Address: TODD J. TIBERI, 227 MULBERRY ST., APT. 4-E, NEW YORK, NY, 10012, US

(21) Appl. No.: 10/756,518

(22) Filed: Jan. 14, 2004

(51) Int. Cl. H04Q 7/20

(52) U.S. Cl. 455/403

(57) ABSTRACT

This invention relates generally to enhanced personal interaction over any network capable of providing a means of communication, such as an online network, for example, the world wide web, internets, intranets, mobile telephone networks, or the like.

### TECHNICAL FIELD

This invention relates generally to enhanced personal interaction over any network capable of providing a means of communication, such as an online network, for example, the world wide web, internets, intranets, mobile telephone networks, or the like.

### BACKGROUND OF THE INVENTION

As computer technology and the internet have become increasingly more important in people's lives, users of these technologies are beginning to demand not only enhanced productivity but also enhanced personalization of their online activities. Online users now have the ability to send instant messages to one another, engage in chat room conversations, create buddy lists, and find prospective dating or love interests via numerous online dating services such as Match.com and eHarmony.com. For example, a number of instant messaging programs are commerically available, allowing users to send and receive text messages to/from a remote user, send and receive files to/from a remote user, and engage in group chat sessions.

Face-to-face meetings and telephone calls are superior and more rewarding methods of communication because in these mediums, behavioral information such as emotions, facial expressions and body language are quickly and easily expressed, providing valuable context within which communications can be interpreted. In email, communication is stripped of emotional or behavioral clues, and the dry text is often misinterpreted because of this absence of emotional or behavioral information. For example, if a sender types, in an e-mail, “I think it may be a good idea”, the interpretation by the recipient is ambiguous. If the recipient could see the sender smile, then the recipient would know the sender is positive about the idea. If the recipient could see a doubtful expression (a raised eyebrow, for example) on the sender's face, the recipient would understand that the sender is unsure whether the idea is good or not. This type of valuable behavior information about a person's state is communicated in face-to-face communication. Other types of emotional information are also communicated in face-to-face meetings. If a person is generally cheery, then this fact is communicated through the person's behavior; it is apparent from the facial and body movements of the individual. If a generally cheery person is depressed, this emotion is also apparent through facial and body movements and will provoke an inquiry from the opposite party. However, in an email environment, these types of clues are difficult to convey. One weak remedy to this problem is the rise of “emoticons”—combinations of letters and punctuation marks that happen to vaguely resemble or are deemed to mean, emotional states such as the now common smile “;-)”.

Telephonic communication provides an advance over e-mail because it also provides audio clues in the speaker's tone of voice which allow a listener to quickly determine, for example, whether a statement was intended to be taken seriously or as a joke. However, telephonic communication provides no visual clues to aid a user in understanding communications, and thus, a listener is often left to guess at what an opposite party is truly intending to convey.

Online dating services provide various levels of communication functionality. For example, some services such as Craigslist.com are limited to a text description of what one desires in a prospective date. Other services such as Match.com and eHarmony.com provide for a user to input various objective attributes (gender, height, weight, hair color, etc.) into an online profile and include a static photograph or a short video clip. Other users can search for a prospective dating partner by inputting their personal preferences. The search may result in a list of the profiles of potential matches. The user then reviews the profiles, which may include a photograph of the prospective date, and decides whether to make contact, typically via email.

Similarly, online users may log into various chat rooms and exchange text messages with either a group of chat room visitors or may engage in one-on-one chatting with a particular visitor in a chat room. In either case, where the individuals desire to evaluate whether they are compatible as possible dating or love interests, they may engage in a prolonged series of text messaging, exchange of photos, telephone calls, and may eventually meet in person. Prior to meeting in person, the on-line interaction typically is impersonal and lacks the important emotional components of real-world interaction.

Also well-known in the art are video games that can be played on a computer, hand-held device, television, or the like. The video games encompass varied scenarios and characters, such as Sim 3000, Grand Theft Auto, Madden Football, and countless others. The games typically involve a human player controlling the actions of one or more computer-generated characters in the game, usually with the purpose of trying to achieve some objective such as building a successful city, defeating an enemy, or winning a sporting event. In addition, multi-player games that allow users at home to play video games with and against remote users are becoming more popular. Finally, in some such games, remote users are able to communicate with one another in real-time, while playing the game, via on-line exchange of text messages or via telephone or the like.

While users of gaming environments may play games and communicate with one another, as with the current on-line dating services, the experience lacks a personal component and hinders a more intimate, emotional interaction. Some attempts have been made to overcome the lack of a more intimate and emotional online interaction. For example, U.S. Pat. No. 6,031,549 relates to directing computer-controlled and computer-generated characters to reflect personalities and moods. U.S. Pat. No. 6,522,333 allows users to communicate behavioral characteristics and moods along with email messages. These systems do not allow for intimate, personal, and emotional interaction that simulates human-to-human interaction in the physical world.

There is a need for personalized virtual interaction that more closely simulates real-world interaction for users seeking to communicate with others for dating, friendship, love, business reasons, or any other reason. Such a system would enable such users to evaluate and experience more natural and emotional human interaction in any number of virtual scenarios.

### SUMMARY OF THE INVENTION

The present invention is directed to a system for personalized virtual interaction over a communication network facilitated by allowing users of such network to interact with one another where images of the users appear and interact with one another in social, entertaining, or other settings. The invention is capable of being used by persons to participate in, for example, virtual dates or any other type of social or other human interactions with others where the actual physical likenesses of the users can be shown in a practically unlimited number of virtual settings.

### DETAILED DESCRIPTION OF THE INVENTION

The invention is described herein in the context of a computing environment. Though it is not required for practicing the invention, the invention may be implemented by computer-executable instructions, such as program modules, that may be executed by a personal computer (PC). Generally, program modules include routines, programs, objects, components, data structures and the like that perform particular tasks or implement particular abstract data types.

The invention may be implemented in computer system configurations other than a PC. For example, the invention may be realized in hand-held devices, mobile phones, multi-processor systems, microprocessor-based or programmable consumer electronics, network PCs, minicomputers, mainframe computers and the like, including any device capable of both visual display and network communication. The invention may also be practiced in distributed computing environments, where tasks are performed by remote processing devices that are linked through a communications network. In a distributed computing environment, program modules may be located in both local and remote memory storage devices.

Before describing the invention in detail, the computing environment in which the invention operates is described. The PC includes a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help to transfer information between elements within the PC, such as during start-up, is stored in ROM. The PC further includes a hard disk drive for reading from and writing to a hard disk, a magnetic disk drive for reading from or writing to a removable magnetic disk, and an optical disk drive for reading from or writing to a removable optical disk such as a CD ROM or other optical media.

The hard disk drive, magnetic disk drive, and optical disk drive are connected to the system bus by a hard disk drive interface, a magnetic disk drive interface, and an optical disk drive interface, respectively. The drives and their associated computer-readable media provide nonvolatile storage of computer readable instructions, data structures, program modules and other data for the PC. Although the exemplary environment described herein employs a hard disk, a removable magnetic disk, and a removable optical disk, it will be appreciated by those skilled in the art that other types of computer readable media which can store data that is accessible by a computing device, such as magnetic cassettes, flash memory cards, digital video disks, random access memories, read only memories, and the like may also be used in the exemplary operating environment.

A number of program modules may be stored on the hard disk, magnetic disk, optical disk, ROM or RAM, including an operating system, one or more applications programs, other program modules, and program data. A user may enter commands and information into the PC through input devices such as a keyboard, and a pointing device, such as a mouse. Other input devices may include a microphone, joystick, game pad, satellite dish, scanner, camera, or the like. These and other input devices are often connected to the processing unit through a serial port interface that is coupled to the system bus, but may be connected by other interfaces, such as a parallel port, game port or a universal serial bus (USB). A monitor or other type of display device is also connected to the system bus via an interface, such as a video adapter. In addition to the monitor, PCs typically include other peripheral output devices, such as speakers and printers.

The PC operates in a networked environment using fixed or transient logical connections to one or more remote computers, such as a remote computer. The remote computer may be another PC, a server, a router, a network PC, a peer device or other common network node, or any other device type such as any of those mentioned elsewhere herein, and typically includes many or all of the elements described above relative to the PC, though there is no such requirement. The logical connections include a local area network (LAN) and a wide area network (WAN). Such networking environments are commonplace in offices, enterprise-wide computer networks, intranets and the internet.

When used in a WAN networking environment, the PC typically includes a modem or other means for establishing communications over the WAN. The modem, which may be internal or external, is connected to the system bus via the serial port interface. Program modules relative to the PC, or portions thereof, may be stored in the remote memory storage device. It will be appreciated that the network connections described are exemplary and other means of establishing a communications link between or among the computers may be used. Additionally, the invention is not intended to be limited to a particular network type. Any network type, wired or wireless, fixed or transient, circuit-switched, packet-switched or other network architectures, may be used to implement the present invention.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

The invention allows connectivity between users, recreating in the virtual world many of the relationship types that users foster in their physical, real-world existence. The virtual world scenarios can be accessed by any conventional means, including connection to a central server, by means of software that can be downloaded onto a user's PC or loaded onto a user's PC, or any other suitable means for a user to access, and an image to appear in, a virtual scenario. The virtual scenarios can be any setting that is capable of being depicted and may be capable of display by any suitable means, including connection to a central server or software stored on a user's PC. The invention allows users to engage in any type or variation of personal interaction.

In one embodiment of the invention, the users communicate through a peer-to-peer connection. This peer-to-peer technology, which is well-known in the art, focuses on the users' individual computers, and organizes communication without the need for a central server. While peer-to-peer technologies have a number of advantages, including independence from a central server and often better resource utilization, the present invention can also be implemented using a central server system, a hybrid system, or any other networking technology.

When the users are online and running this application, they have the ability to interact in an essentially unlimited number of ways. Although a number of activities are described below, these activities are simply representative and are not meant to be limiting of the scope of this invention. Using different program modules that can interact with the described application, any activity that can be implemented in code and shared by differently located users can be implemented within the invention.

In one preferred embodiment, a user is able to interact with another user, typically located at a location remote from the first user, in a virtual setting. Of course, the users can be in the same location and even using the same PC. For example, assume Adam and Beth are located remotely from each other and each has their personal communication device, such as a PC, connected to the communication network, such as the internet. After communicating with one another to pre-arrange a meeting, Adam and Beth can agree to go on a virtual date in any number of scenarios. For instance, they can agree to virtually meet at the Eiffel Tower. Images displayed on each of their PC screens can be the two of them meeting outside the tower and then walking to a restaurant, sitting down, and ordering dinner. Movements and actions of virtual images can be accomplished by any number of means, including a keyboard, mouse, joystick, game pad, voice-activated means, eye-movement activated means, or any other suitable means that can bring about movements or actions of images displayed on a PC.

Rather than displaying the impersonal images of human forms already programmed into software running a program, in one preferred embodiment, the images displayed are of the faces or any portion of the bodies of Adam and Beth. Such images can be inserted into the virtual scenarios by any number of methods, such as transmitting a digital photograph to a server capable of inserting the photograph into the virtual scenario. One method is available through Cyberextruder.com, which offers services that include converting a two-dimensional image into a three-dimensional image and putting the image in a video game. Displaying actual images of the users offers a more personal and intimate experience that better simulates real-world person-to-person interaction. While at the virtual restaurant, Adam and Beth can communicate with one another by, for example, sending instant messages, email, chatting, or speaking into microphones or the like. Under any of these communication methods, the images of their mouths and/or faces can optionally be capable of corresponding to the communications. For example, the images of their mouths can correspond to the words being communicated.

In another preferred embodiment, the images of the users displayed in the virtual scenarios can include their live images. For example, the users can use a webcam, or other suitable means, to capture their live images. Webcams are commonly available from such sources as Webcamworld.com. Such images can then be inserted into the virtual scenarios in real-time. Each user's actual movements, facial expressions, laughter, concern, etc. thus would be displayed on the PC screens of each user, thereby further enhancing the personal and intimate experience to better simulate real-world person-to-person interaction.

In another preferred embodiment, users can employ devices to engage or enhance various sensations among the human senses, e.g., touch, feel, smell, sight, sound. For example, users can employ an apparatus that conveys tactile sensation. For instance, if Adam and Beth were to shake hands in the virtual scenario, either or both of them could experience the sensation of hand-shaking by use of special gloves that transmit the sensation displayed on the screen. Optionally, in another preferred embodiment, the sense of smell can be engaged. For example, if Adam and Beth had a virtual date at the beach, the smell of the ocean could emanate from their PCs, perhaps due to known compact disks that are designed to emit any number of smells and may be linked to the virtual scenario. Again, any of these preferred embodiments would better simulate real-world interaction.

In another preferred embodiment, the perspective of a user can be changed. For example, rather than having the display show the bodies of the users from head-to-toe, users can observe the display from their own point of view, or from any other perspective, such as from overhead, far-way, close-up, or in different colors or lighting.

As disclosed above, the number of scenarios in which users may interact is practically limitless. For example, the scenarios can include houses, rooftops, restaurants, movies, bars, parties, parks, beaches, mountains, woods, airplanes, boats, cars, highways, theaters, sporting events, concerts, historical settings, or any other real-world or even fantasy-world locations capable of being portrayed in an image. The scenario can be either from the past, present, or future. For instance, users virtually can attend the Gettysburg Address and then virtually travel to a restaurant in Sweden to discuss it afterward. Of course, the inventions and various embodiments are not limited to two users in any scenario. There can be one or a plurality of users in any scenario as well as zero, one, or a plurality of images of other characters in any scenario. For example, one scenario can be a “singles bar” where a plurality of single people mingle and communicate with one another similar to such activities in the real, physical world.

It should be apparent that the user activity is not limited to social interaction. In one preferred embodiment, a user can engage in recreating well-known historical events or in creating future events. For instance, a user can insert her image in the scenario of the first person to walk on the moon, making it appear that she was with the first such person. It should be apparent also that the present invention can be used for training or teaching purposes in any number of scenarios. The insertion of the user's actual likeness, or actual real-time movements, should enhance the effectiveness of the training or teaching, as the user will feel a greater personal connection to the activities on the screen. In all scenarios and embodiments described herein, any image can be employed by the user, and the image need not actually be one of the user. For instance, a user can insert the image of the user's friend or anyone else in any of the scenarios. In addition, the invention contemplates that a single user can engage in activities in a scenario where others in the scenario are controlled either by the same single user or by computer rather than another human being. The invention also contemplates, in one preferred embodiment, that the activities in a scenario may optionally be saved by a user and stored in electronic or other suitable form.

In view of the many possible embodiments to which the principles of this invention may be applied, it should be recognized that the embodiments described herein are meant to be illustrative only and should not be taken as limiting the scope of invention. For example, those of skill in the art will recognize that the elements of the embodiments described as being in software may be implemented in hardware and vice versa or that the embodiments can be modified in arrangement and detail without departing from the spirit of the invention. Therefore, the invention as described herein contemplates all such embodiments as may come within the scope of the following claims and equivalents thereof.

1. A method for personal interaction in a virtual setting, comprising:
providing a communication device having a visual display;
providing a scenario displaying means capable of depicting a plurality of scenarios on the visual display;
providing an image inserting means capable of inserting an image selected by a user into the visual display; and
providing a controlling means capable of allowing the user to control movements and actions of the image.

2. The method according to claim 1, wherein the communication device is communicably linked to a communication network.

3. The method according to claim 1, wherein the communication device is communicably linked to a communication network and to another user.

4. The method according to claim 1, wherein the image is a likeness of the user.

5. The method according to claim 1, wherein the image is a dynamic, real-time likeness of the user.

6. The method according to claim 1, wherein the communication device includes a means to engage the senses of smell, taste, touch, feel, sight, hearing, or the like.

7. The method according to claim 1, wherein the personal interaction takes place between one or more users.

8. The method according to claim 1, wherein the personal interaction takes place between two users.

9. A system for personal interaction in a virtual setting, comprising:
a communication device having a visual display;
a scenario displaying means capable of depicting a plurality of scenarios on the visual display;
an image inserting means capable of inserting an image selected by a user into the visual display;
a controlling means capable of allowing the user to control movement and actions of the image.

10. The system according to claim 1, wherein the communication device is communicably linked to a communication network.

11. The system according to claim 1, wherein the communication device is communicably linked to a communication network and to another user.

12. The system according to claim 1, wherein the image is a likeness of the user.

13. The system according to claim 1, wherein the image is a dynamic, real-time likeness of the user.

14. The system according to claim 1, wherein the communication device includes a means to engage the senses of smell, taste, touch, feel, sight, hearing, or the like.

15. The system according to claim 1, wherein the personal interaction takes place between one or more users.

16. The method according to claim 1, wherein the personal interaction takes place between two users.
